(19) United States
(12) Patent Application Publication
(10) Pub. No.: US 2013/0066795 A1
(43) Pub. Date: Mar. 14, 2013

(54) Resume ID System

(71) Applicants: Howard B. Katz, Boca Raton, FL (US); Stephan P. Katz, Woodcliff Lake, NJ (US)

(72) Inventors: Howard B. Katz, Boca Raton, FL (US); Stephan P. Katz, Woodcliff Lake, NJ (US)

(21) Appl. No.: 13/534,205

(22) Filed: Jun. 27, 2012

Related U.S. Application Data
(60) Provisional application No. 61/571,617, filed on Jul. 1, 2011.

(51) Int. Cl. G06Q 10/06

(52) U.S. Cl. 705/321

(57) ABSTRACT

A computer-operated method for distributing job-seeker qualifications to hiring entities comprises job-seeker registration and secure internet entry/uploading, of personal data into a program administrator server, to selectively populate one or more data fields, including a résumé module, a photo/video module, a verification module, and a pre-employment screening module. The job-seeker selects a distribution security scheme, which may include requiring a password to view data, and the program administrator encodes a bar code based upon inputted data and filter/security selections, and sends the bar code to the seeker, who forwards the bar code to one or more hiring entities, who use it and a password for online viewing of the seeker's personal data. The bar code is customizable to be hiring-entity-specific and to permit only selective viewing of the entire stored databank, and may also be subsequently disabled. The bar code facilitates seeker tracking of a time/date of data viewing.

### CROSS REFERENCES TO RELATED APPLICATIONS

This application claims priority on U.S. Provisional Application Ser. No. 61/571,617 filed on Jul. 1, 2011, the disclosures of which are incorporated herein by reference.

### FIELD OF THE INVENTION

The present invention relates to improvements in résumé collection and distribution, and more particularly to a method that permits more flexible and diversified distribution of such qualifications/employment information.

### BACKGROUND OF THE INVENTION

The prospect of searching for and applying for a first job or a new job is usually a daunting task. There are numerous different ways to search for a job, with the method of job searching often entailing a different method of applying for and of submitting the required information, including submission of the applicant's résumé. For example, an employer may advertise employment positions in various print media, despite a steady decline in the circulation by such media outlets. Examples of such print media may include daily newspapers, or trade publications such as Computer Weekly magazine that has maintained a recruitment section therein referred to as Career Moves, and Contract Employment Weekly for recruiting within many engineering disciplines, both of which have also become available in digital format. The traditional newspaper listing often requests that the job seeker fill out of an application in person, or requests the mailing of a résumé to a designated staff member.

A job seeker may also be diligent in directly seeking out, on the World Wide Web, corporate web sites for particular firms that the searcher is targeting. These websites usually include a “Careers” tab that list employment positions currently available at different corporate locations throughout various regions of the country. To request consideration for one of those positions typically requires filling out the information boxes of an online job application, which essentially comprises selective entry of all of the job seeker's résumé information. Other corporations and companies that do not specifically list available positions, will often state on its website that they regularly seek qualified personnel, and request that interested parties send a résumé and cover letter to a personal director at the company's address.

For many disciplines, there are industry-specific recruiters, such as for the hiring of medical practitioners (e.g., texashotjobs.org for health opportunities in Texas), or the hiring of engineers, or lawyers—recruiters who may also request a résumé and cover letter to begin the recruiting process.

It is also common for a job-seeker to search online using one or more generalized job websites that include: monster.com, hotjobs.com, careerbuilder.com, indeed.com, snagajob.com, simplyhired.com, usajobs.com, jobsearch.about.com, careeronestop.org, theladders.com, etc. Many of these sites require signing up for access by providing the job-seeker's email address and a password, and may thereafter permit uploading of a résumé or creating of an online résumé by typing/pasting of data into information boxes on a page of the website.

In addition, the prolific use of the internet has also led to the creation of the professional/social networking website known as LinkedIn, which allows a registered user to establish and maintain a contact network, and also includes an “Apply with LinkedIn” button leading to job listing pages.

Even after the job seeker has successfully applied for a multitude of advertised job openings, a process which may nonetheless continue until actually receiving a confirmed offer of employment, the hiring company generally will require many other additional pieces of information and/or documents, either prior to the making of a formal offer, or prior to the actual start of employment, or possibly after the first work day in order for the person to survive a probationary period. For example, it is not uncommon for a company hiring an engineering student directly from college to request a copy of the person's diploma, to verify that graduation occurred, which the company may keep on file. Where a law firm may be hiring an associate having only 1-3 years of experience, the firm may request to see a law school transcript, and if the attorney's undergraduate experience is a significant factor in the hiring, such as for a patent attorney, the firm may also request to see the applicant's undergraduate college transcript which documents the applicant's technical education.

Certain other documents may also be crucial to complete the hiring process, such as, for example, those relating to recurrency training. For the attorney, the question may be whether the applicant has satisfied the state's requirement for continuing legal education (CLE), for which a certificate of attendance is given and must be held for a period of time to document course completion. For a professional pilot, his/her medical certificate must be current, he/she must receive “retraining” twice per year if flying for an airline, otherwise a biennial flight review must have been conducted and logged, and if the pilot is an instructor, he/she must have timely completed a flight instructor renewal course, which results in the issuance of a temporary certificate. U.S. regulatory guidelines also require that all Hazmat workers receive mandatory recurrent hazardous materials training within a specified time period, for which a certificate of completion is awarded.

There have been a number of inventions, to date, that are directed to the storing and submitting of a résumé for the job seeker, but they do not go far enough in providing flexibility in the process, and they do not sufficiently aid the job-seeker in completing the overall process of being hired and retained. The present invention addresses these shortcomings of the prior art.

### OBJECTS OF THE INVENTION

It is an object of the invention to provide an electronic means of distributing qualifications of a job seeker to one or more hiring entities or one or more agents of a hiring entity.

It is another object of the invention to permit internet access, by a hiring entity, to selective aspects of stored personal data of a job seeker.

It is a further object of the invention to provide an in-depth data verification means for an employer to pre-screen and determine the existence of requisite qualifications of a job seeker.

It is another object of the invention to provide a coded means of controlling internet access granted to a hiring entity by a job seeker for selective aspects of stored personal data of the job seeker.

Further objects and advantages of the invention will become apparent from the following description and claims, and from the accompanying drawings.

### SUMMARY OF THE INVENTION

A computer operated method for distributing qualifications of a job seeker to one or more hiring entities or one or more agents of a hiring entity may initially comprise registering, by a customer, using a customer login web page hosted by a server computer. The job seeker may thereafter enter and/or upload personal data securely into the server computer to populate one or more data fields. The job seeker may also select a distribution security scheme that may customize how the stored data is to be distributed, and how much data is disclosed to various different recipients. Based upon the information submitted, the filtering, and the selected security scheme, the server computer may generate a coded ID and issue it to the customer. The coded ID may be in the form of a bar code, such as the Universal Product Code (UPC) having 12 numerical digits represented by a scannable strip of black bars and white spaces, or the European Article Number (EAN), being a 13 digit (12 data and 1 check) bar coding standard, or more preferably it may be in the form of a Quick Response (QR) code.

In one embodiment of the invention, the job seeker may receive the coded résumé ID from the system and add it onto a cover letter or a résumé or both, and then conventionally mail or e-mail the cover letter plus resume themselves, to various companies advertising open positions or to various employment websites, etc. The recipients may submit, online, the bar code, and possibly a required password, to the server computer, which verifies the bar code, and that it has not been disabled by the job seeker, after which all of the stored data that was approved for viewing is revealed to the bar code recipient. The system may notify the job-seeker of the time and date of viewing of the data by the recipient.

In another embodiment of the invention, the job seeker may enter a complete cover letter into the system, and may also identify recipient names and addresses. The server computer of the program administrator of the Résumé ID system may then prompted to e-mail the bar-coded résumé and cover letter to recipients directly from within the system.

There are many different types of data that the job seeker may make available within various modules of the current invention, to proactively provide the prospective employer with a more complete picture of the applicant's full qualifications. The data entered by the job seeker may be appropriately entered into a Cover Letter Module, a Résumé Module, a Verification Module, a Photo/Video Module, a LinkedIn Module, a Facebook Module, and a Pre-Employment Screening Module. Uploading of data into each module supplies a comprehensive biography of the applicant's employment qualification, far beyond what may be gleaned from simply reading the person's résumé.

The Pre-Employment Screening data may comprise uploading of one or more of the following: a credit report; a criminal background report; and a worker's compensation claim search report. The Verification Module may comprise uploading evidence of one or more of the following: a high school diploma; a trade school diploma; an undergraduate degree diploma; a graduate degree diploma; a school or college transcript; an award or honors certificate; a proof of citizenship document; a language proficiency test result; a passport information page; a stamped passport travel page; a published paper; a published book; a professional certification document; an issued patent; a recurrency training certificate; a professional society membership certificate; a leadership certificate; a certificate evidencing a fellowship or internship; a research grant document; a business formation document; a security clearance; a military service certificate of discharge; a community group certificate of participation; a volunteer group certificate of participation; an organizational certificate of participation; a certificate of church membership; a professional reference.

### BRIEF DESCRIPTION OF THE DRAWINGS

FIG. 1 illustrates an initial registration screen for a job seeker to begin the process of enrolling in the Résumé ID system.

FIG. 2 illustrates a login screen to access the registrant's account that is maintained by the administrator of the Résumé ID System.

FIG. 3 illustrates an enrollment screen within which a job-seeker may input or upload information into the Résumé ID system, by typing the required data into information boxes.

FIG. 4 illustrates a secure screen being usable by the registered hiring employer for logging in to the system and for supplying of a Résumé ID forwarded to them from an applicant, in order to display the relevant biographical and other data of the corresponding applicant.

FIG. 5 illustrates a first embodiment of the Résumé ID display screen of the present invention.

FIG. 5A illustrates a second embodiment of the Résumé ID display screen of the present invention.

FIG. 5B illustrates a third embodiment of the Résumé ID display screen of the present invention.

FIG. 6 illustrates a résumé of an information technology executive being displayed in the Résumé ID system of the present invention.

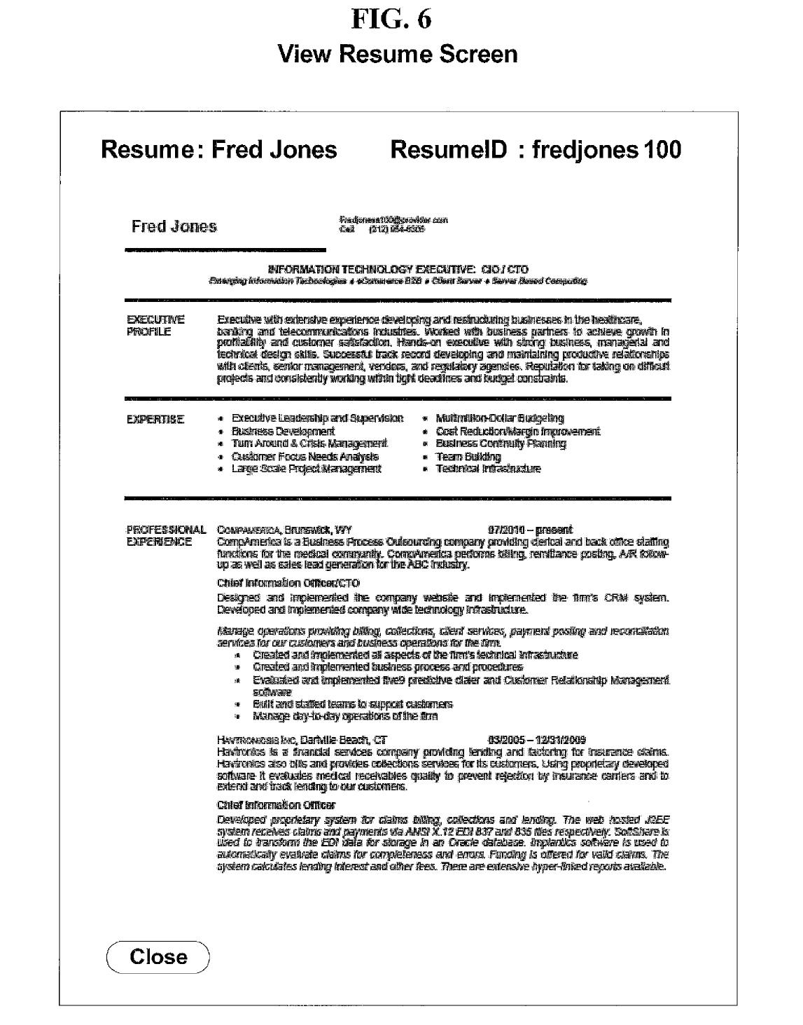

FIG. 7 illustrates a résumé of an individual utilizing the Résumé ID system of the present invention, with the résumé including the individual's unique bar code permitting access to the full array of inputted and stored data of the individual within the system.

FIG. 8A is a flow chart illustrating operation of one embodiment of the Résumé ID system of the present invention.

FIG. 8B is the continuation of the flow charted operation of FIG. 8A.

FIG. 9A is a flow chart illustrating further operation of the embodiment of the Résumé ID system of FIG. 8A.

FIG. 9B is the continuation of the flow charted operation of FIG. 9A.

FIG. 10 is a schematic of an exemplary computing unit interacting with external peripherals and other computers over the Internet, and being capable of running the software of the current invention.

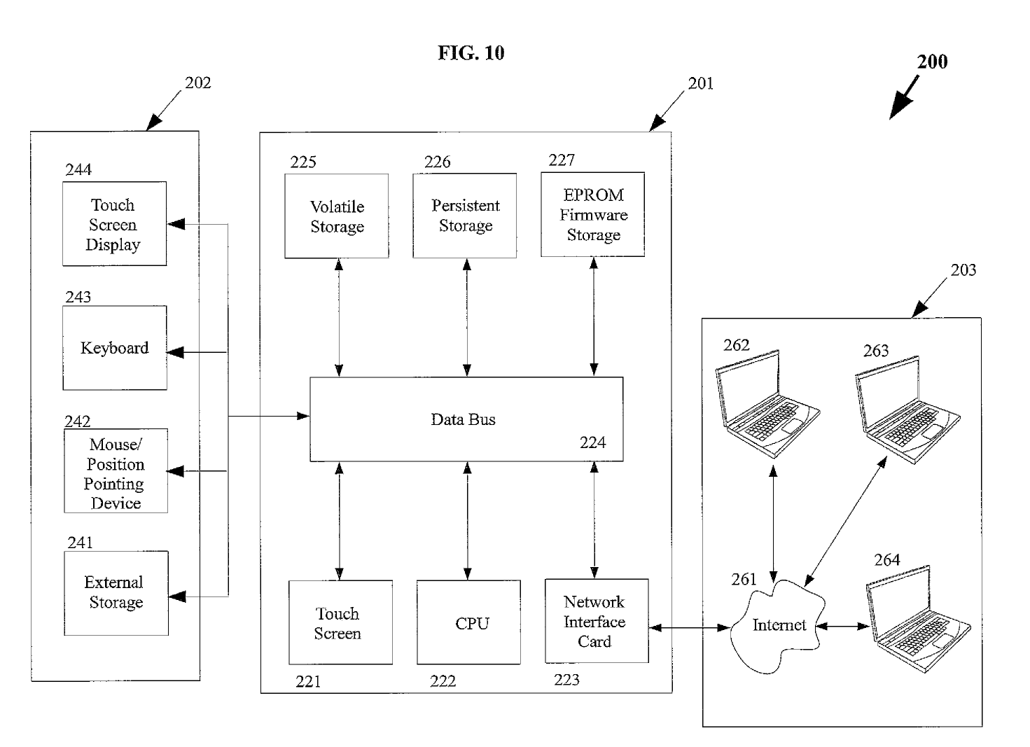

### DETAILED DESCRIPTION OF THE INVENTION

This method of the present invention comprises conveying personalized information, including at least a résumé, between two parties using Globally Unique Identifiers (GUID). The process may begin with a customer—a current or prospective job-seeker—registering online with the program administrator, who may operate a hosting site using a secure server or other suitable computing device. The customer may be a prospective or future job seeker, in that it may be advantageous for any individual to assemble the documentation discussed hereinafter and organize it within the system of the current invention, so that if/when their employment situation suddenly changes, they will be immediately ready to utilized the system in seeking other opportunities, just as it may otherwise be prudent to routinely update one's résumé.

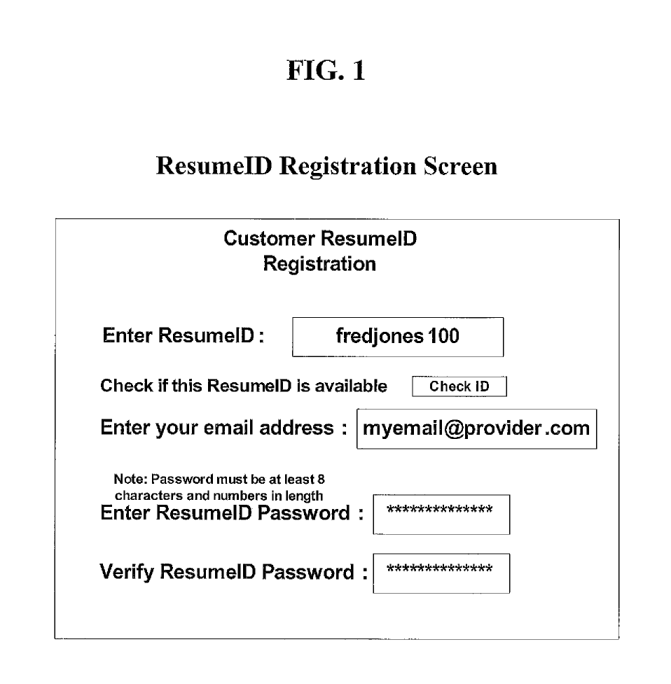

A customer-job-seeker, exemplified herein using the fictional name of “Fred Jones,” may create an account in the system using a Registration web page, which is illustrated in FIG. 1. Registration may initially entail providing an e-mail address and a password, and may further require providing credentials that uniquely identify themselves to the system, which may, but need not necessarily be, the person's social security number. In that respect, the process and system disclosed herein is not limited to job-seekers who are citizens of the United States, and may instead serve as an international platform for the conveying of personalized information relating to employment, and may thus also be offered to non-nationals.

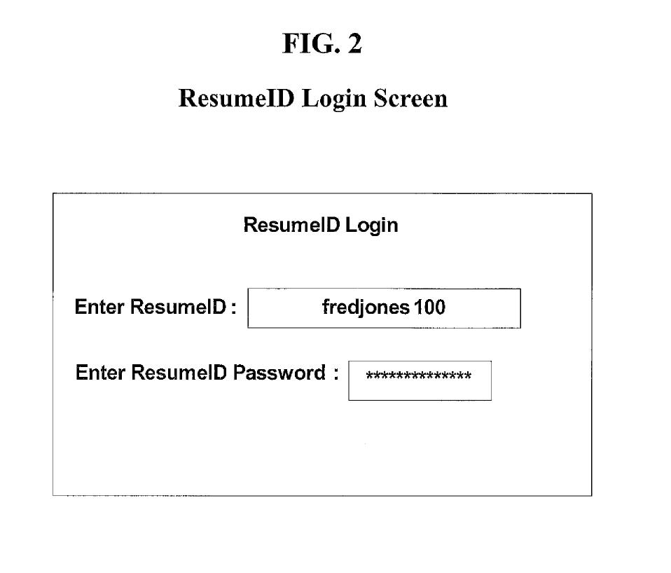

After successful registration, for which the registrant may be charged a nominal fee, the system may send the Customer an email to verify the email address that was entered, and it may request that the Customer respond to the email to verify its receipt and confirm registration in the system. Subsequent access by the registrant into the system may be made using the login screen depicted within FIG. 2.

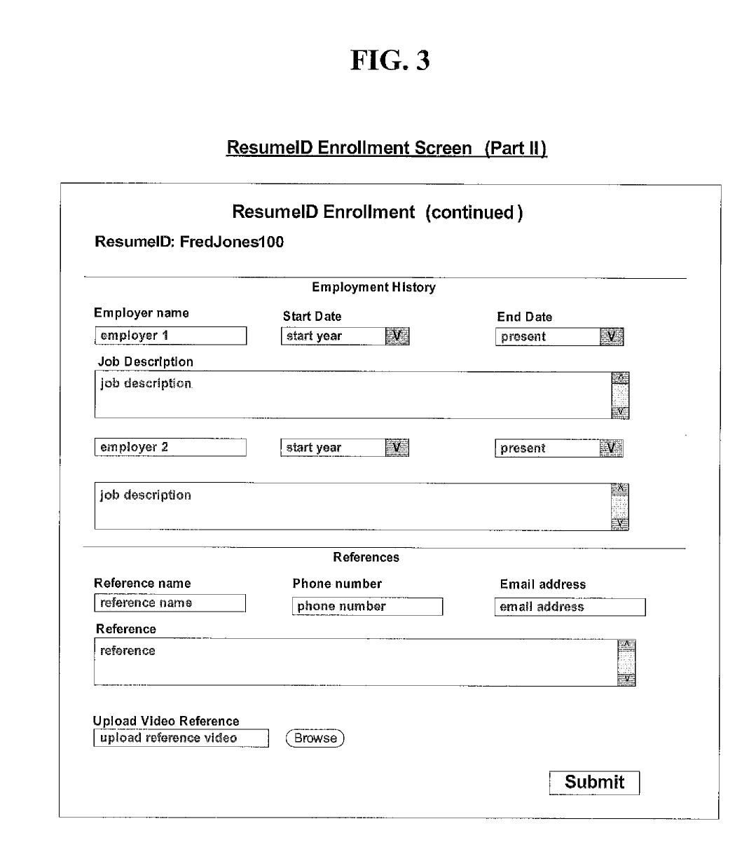

Once registered in the system, the job seeker may then proceed to fully enroll in the process and begin using the system by first entering his/her résumé information via the Enrollment web page seen in FIG. 3. The enrollment web page may allow the job seeker to cut and paste select data from a résumé that had already been constructed using document preparation software, such as Microsoft's Word program or Corel's WordPerfect program. The data may be pasted into specific information boxes on the web page, and may be segregated according to categories, such as education, employment, skills, etc. The job seeker may thereby construct an online résumé by pasting in a sequential listing of previous employers that he/she may have worked for, along with dates of employment and job descriptors, etc.

As an alternative to re-creating the person's résumé by the cut/paste method or by inputting it manually into the information boxes of the web page, the person may instead be given an option to upload an existing résumé from a software program, or upload it by scanning the résumé into the system. Throughout this disclosure, the use of the term “scan” or “scanning” is intended to include any one of the possible scanning methods currently known or later developed, such as the scanned image raster file formats like BMP, TIFF and JPEG, or Adobe's PDF format (in raster, vector, or hybrid form). Depending upon its method of entry, additional options may be offered with regard to the utility and the presentation of the résumé, such as the ability of doing keyword searches.

In addition to the presentation of a résumé, the software of the present invention may include a photo/video module that may permit uploading of one or more photographs of the individual, as well as uploading of a video. Several Universities now permit prospective students to post a one minute YouTube video that says something about them, to supplement the conventional written application and essay. Although the use of video recordings is not currently a standard practice to supplement employment applications, there are an increasing number of companies that screen job candidates using pre-recorded video interviews. This is particularly useful where the candidate lives at a distant location from the company, possibly even being outside of the country, and it would be more efficient and economical to do preliminary screenings in this manner, before an onsite visit is offered. The company, possibly as part of the job posting, may list a series of questions and requirements that the candidate is to address, and the candidate may do so in a video recording. Professional video recording companies, such as Hire*Vue, offer a digital interview platform to assist in the process. These videos may be uploaded into the system of the present invention.

As part of the hiring process, an employer will very often require additional information in screening candidates or new hires, which may nonetheless be permitted to begin work for a trial or probationary period, before being permanently admitted to the staff. In some instances, the employer may not permit the start of even a probationary work period without prior satisfaction of a pre-employment screening check. Therefore, the method of conveying qualifications of a job seeker to one or more hiring entities or one or more agents of a hiring entity within the present invention may therefore also comprise a novel pre-screening verification module for ascertaining certain background qualifications and overall compatibility of the job seeker with the requirements of an employer.

For example, some employers may be concerned about the prospective employee's credit history, in the belief that it may reflect upon the integrity with which the employee will conduct themselves in the new job, particularly where they are required to handle large sums of money. Other employers may also require a more extensive background check of the employee to include the existence of a criminal record or any arrests that may unfavorably reflect upon the firm. In other instances, the company may wish to learn if the prospective employee has ever filed one or more worker's compensation claims. As part of the method of the present invention, the job seeker may pro-actively increase his/her prospects of being viewed favorably and of being offered a position, by supplying this data up front, in the pre-employment screening module of the present invention. The job seeker may thus obtain a copy of their credit report from one or more of the three major credit reporting agencies, and scan it and upload it into the system within this module. The job-seeker may also request and obtain a more extensive background check that may also be posted within the module.

In fact, there are a large number of other qualifications that the company may require knowledge of or verification of, before making an offer of employment, and there are also other qualifications or experiences that may be helpful in persuading the employer to seriously consider the applicant, even if they are not formal requirements. Documents attesting to such qualifications may similarly be uploaded within a Verification Module of the present invention.

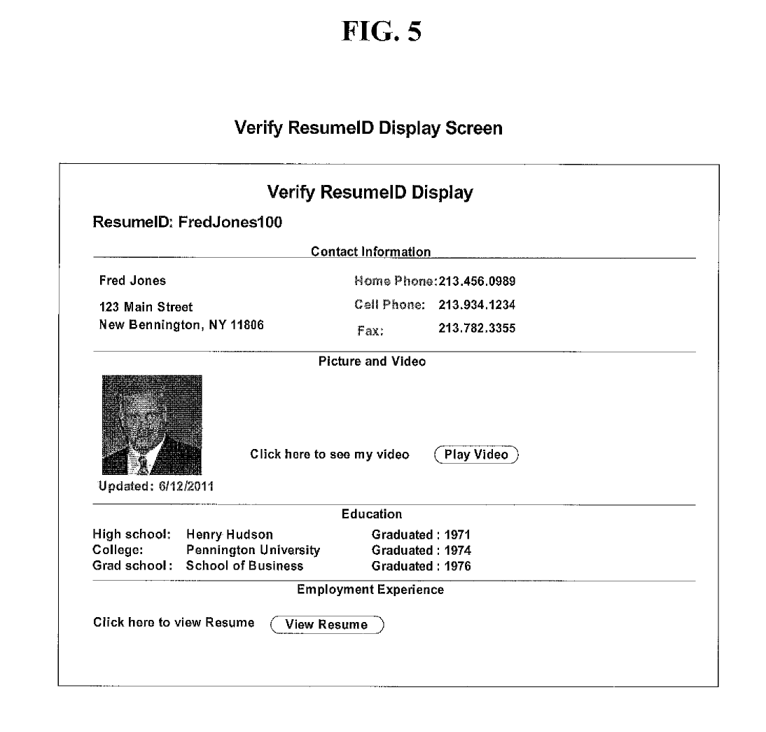

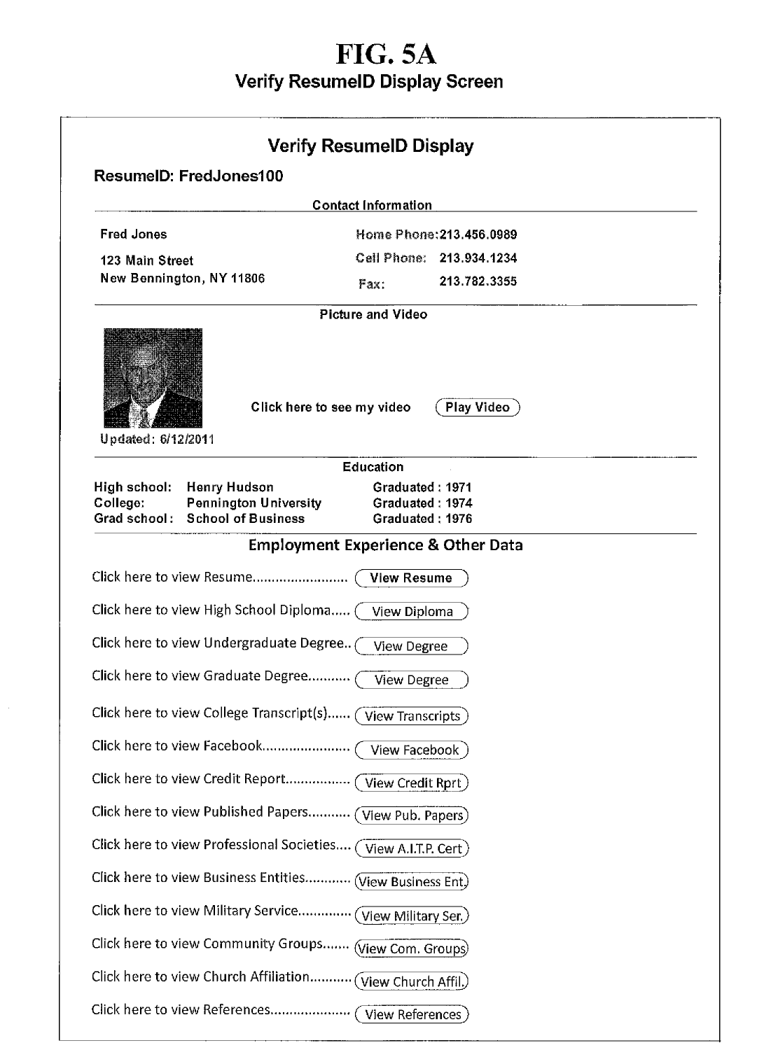

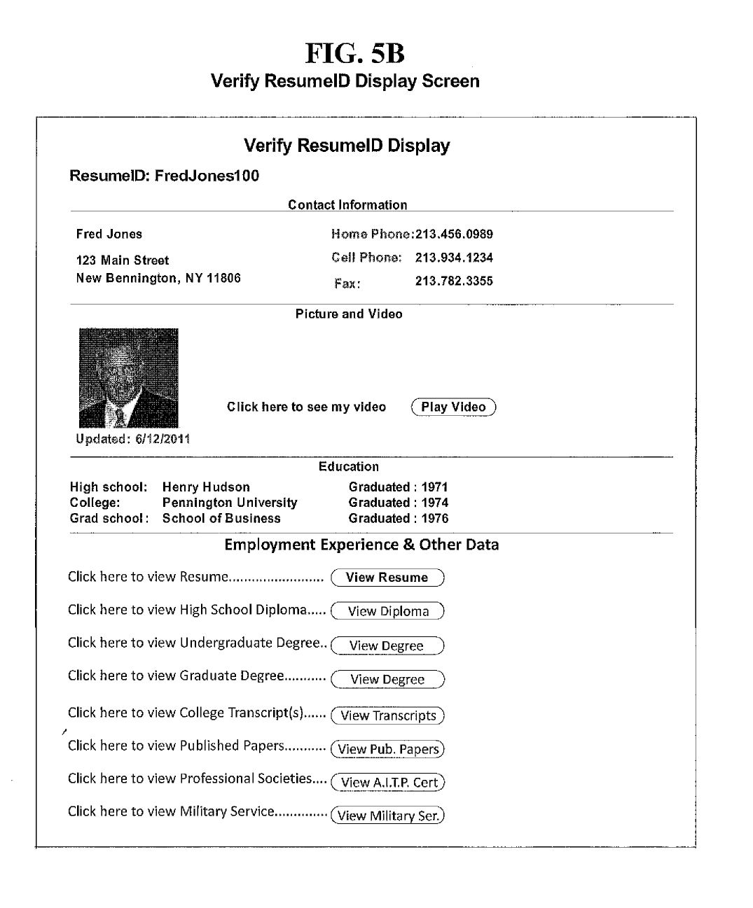

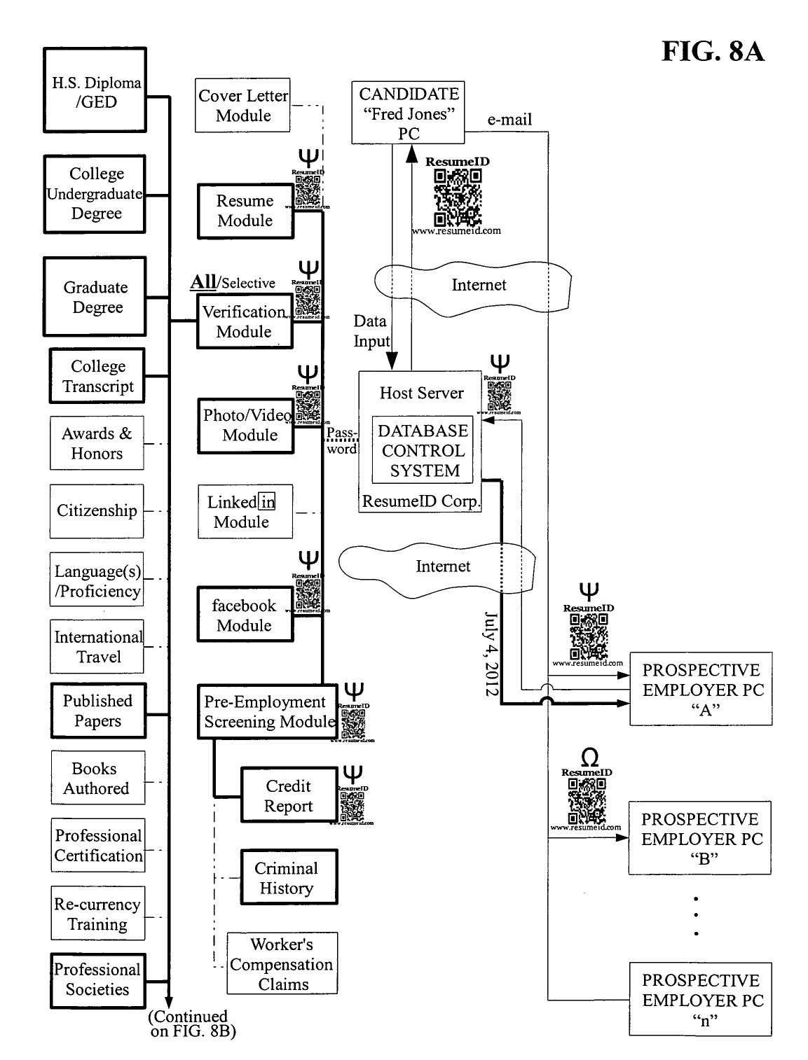

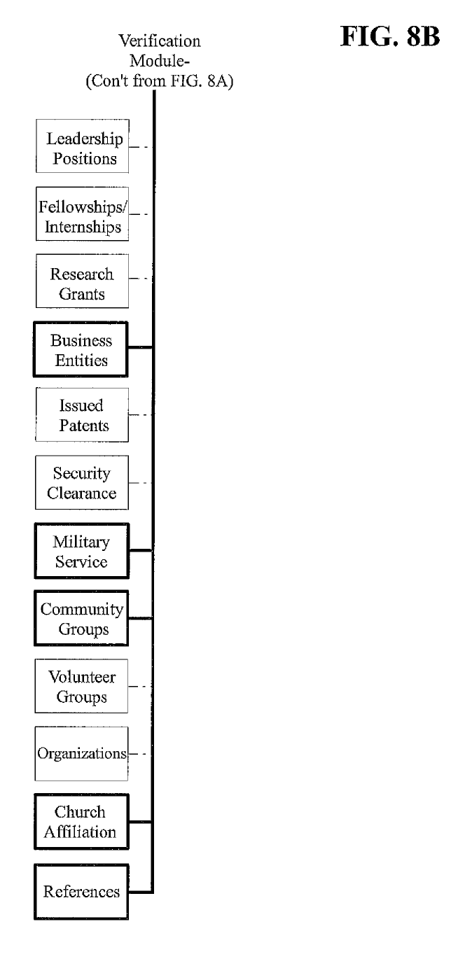

For example, the minimum educational requirement for certain jobs may be that the prospective employee be a high school graduate or hold a GED, while other positions may require an Associate Degree, a Bachelor's degree, or even the completion of graduate studies resulting in the awarding of a Master's or a Doctorate (PhD) degree. These educational achievements are ordinarily documented by the issuance of a diploma, which may be scanned and uploaded into a Verification Module of the present invention. This Verification Module, along with other aspects of the present invention (Pre-Employment Screening Module, Résumé Module, Photo/Video Module, and Cover Letter Module), is shown within the flow chart of FIG. 5A, which continues onto FIG. 8B. By scanning these documents and uploading them into the verification module of the present invention, the employee may preemptively satisfy the employer's eventual requirements, and offer a more complete packaged presentation of the applicant's qualifications. It may thus benefit the job applicant who wishes to highlight the full extent of their qualifications, beyond the summary found on the person's Résumé, and it may also benefit the employer as well, who may wish to glean a more in-depth perspective on the applicant's accomplishments and suitability, before extending an invitation for a formal interview.

There are many more aspects of the Verification Module that may be included to mutually benefit both the employer and the job-seeker. For example, there are many positions that require specific training and attainment of a requisite level of knowledge that may not be reflected by the mere granting of a diploma. A prestigious patent law firm that specializes in pharmaceutical patents may not only consider the academic record of a recent law school graduate for the filling of an open position, but may also be particularly interested in the coursework and specific course grades attained by the applicant's in pursuit of their technical degree, particularly if the person did not complete any graduate work. Therefore, the Verification Module may also be adapted to upload a scanned copy of the job-seeker's transcripts, for each level of education completed.

Similarly, any awards and honors that were bestowed upon the job seeker may also be uploaded into the Verification Module for presentation and review by the prospective employer. This may include making the dean's list at an education institution, being invited into an honor society (e.g., Phi Beta Kappa Society for liberal arts, or Tau Beta Pi for engineering), receiving a CALI award for a course at law school, being a Valedictorian or Salutatorian of a graduating class, etc. These awards are typically documented with a certificate or a plaque, and may furthermore be published within a graduation program, so the image of each may be scanned and uploaded into the Verification Module.

For certain jobs, the citizenship of the applicant may be an issue, in that it may be a requirement that the prospective employee be a U.S. citizen, which may be documented in the system by scanning and uploading one or more documents. These documents may include: a certified birth certificate; an issued and undamaged passport; a consular report of birth of a U.S. citizen or a certification of birth; a naturalization certificate; and a certificate of citizenship. Conversely, a firm may be seeking to form a business association with a company located in another country or may be seeking to work on developing a business relationship with that country as a whole, and may preferably be seeking to hire a foreign national who holds citizenship in that nation to work as a liaison. In this case, such citizenship documentation for that country being uploaded and available in the Verification Module of the present invention would be advantageous in advancing the job seekers prospects of employment.

Similarly, the employer may additionally, or alternatively, be concerned with the proficiency with which the job seeker is fluent in one or more different languages. For a company that is seeking an employee who possesses the specialized technical knowledge of a scientist, an engineer, or a programmer, and may consider serving as a sponsor for an H-1B non-immigrant, the job seeker's proficiency in the English language may be a significant consideration. Conversely, for a company seeking to hire an employee to serve as a liaison in a foreign nation, for example, the hiring of a worker to interface with a counterpart in Berlin, the job seekers ability to speak the native language of that country—German in this example—is paramount. There are many entities that offer proficiency testing in various languages (e.g., Language Testing International). So, a diligent applicant seeking to proactively demonstrate linguistic capabilities, may sit for such testing, and may thereafter provide the resulting documentation to the Verification Module of the present invention, so that it may confirm the proficiency claim that may be present within the person's résumé.

In addition to the above, a company, due to the nature of the open position, may also or alternatively be concerned with the applicant's ability to immediately participate in international travel, which may be proven by the existence of a valid passport. So, the job seeker may scan the date page of his/her passport and upload it to the Verification Module of the present invention to certify their readiness for the international travel. Moreover, if past foreign travel to a particular country is a stated plus or requirement for the employer, such as for the above liaison position in Berlin, Germany, the job seeker may also scan the travel pages of his/her passport that record travel to Germany or any other German-speaking country, and thereby provide documentation of such specific overseas travel experience.

There are numerous other accomplishments, qualifications, and points of interest for which corresponding documentation may be scanned and uploaded into the Verification Module of the present invention, without a detailed explanation of the value of such data to the prospective employee. For example, an applicant may have published several articles, which may be scanned and uploaded, or may have authored a book that was published, which may not necessarily be scanned and uploaded in its entirety, except for perhaps the title page and the back cover to identify its ISBN number.

Documentation of any Professional Certifications, such as for being Board Certified in a medical/dental specialty (ABMS, AOABS, or ABPS), or being a Certified Flight Instructor, etc., may be uploaded into the Verification Module. Recurrency training is required for many fields, such as the U.S. Regulatory guidelines requiring recurrent training for a hazardous materials worker, or Bar Association requirement of continuing legal education (CLE) for attorneys, or the twice-yearly retraining for an airline pilot, each of which may result in the issuance of a certificate that may be scanned and uploaded.

The job seeker may be an active member of certain professional societies, such as the American Association of Mechanical Engineers (ASME), or the Institute of Electrical and Electronics Engineers (IEEE), or the American Medical Association (AMA), or the Association of Information Technology Professionals (AITP), which may be documented by the scanning and uploading of a membership certificate.

Any leadership positions held, such as being a Boy or Girl scout leader with possible attainment of a high ranking such as that of Eagle Scout, or being the head of a committee such as a Bar Association committee, may be documented in the Module. Any fellowships, or internships, or research grants received may be so documented. If the person formed their own S-corporation of C-corporation or other business entity, the articles of incorporation attesting to such corporate formation may be scanned and uploaded into the Module. If the person received any issued patents, those may similarly be scanned and uploaded into the system. Documentation attesting to a security clearance or military service (honorable discharge certificate) may be added to the Module.

Although it may not necessarily be useful or appropriate for a conventional job application, documenting of certain non-work associations and involvement may be beneficial where the system of the present invention is used for attracting a volunteer to perform public service work, or for a non-governmental organization (NGO), or a not-for-profit organization. In such cases the customer of the system may upload documentation pertaining to his/her participation in any community groups (e.g., Big Brother/Big Sister Association, Boy Scouts or Girl Scouts, a local Food Pantry, etc.), or Volunteer Groups (e.g., Peace Corps, Doctors Without Borders, American Red Cross, etc.), or Organizations (Jaycees, Sierra Club, etc.), or church affiliations.

In addition to the Résumé Module, Verification Module, and Pre-employment Screening Module described above, the software of the present invention may accommodate a Facebook Module that is adapted to supply a link permitting “friending” with the employer on Facebook. While providing open access to a person's Facebook account may be a norm for certain professionals, especially where the person is a public figure such as a television personality and social networking ensures future success and ratings, certain other users do not plan to utilize Facebook except for providing access to their photos or wall for close personal friends. Therefore, a temporal link for the hiring company may be established where the customer of the present system so elects.

As stated earlier, operation of the software and method of the present invention initially comprises registration and completion of enrollment, which may include the entry of all résumé and any/all other relevant information described hereinabove. Once that has been competed, the customer of the system can leave the information dormant within the system if they are not yet pursuing a job or volunteer position. If the Customer is currently seeking a job, he/she may proceed to the next step, which entails identifying a prospective employer, and identifying which data within the entire bank of information within the system, they wish to make available for viewing by a particular company.

As seen in FIG. 8A, the fictional job seeker (“Candidate” Fred Jones) has entered/uploaded his résumé data within the Résumé Module, as well as a High School Diploma, Undergraduate Diploma, Graduate Diploma, College Transcripts, Published Papers, a Professional Society Membership (e.g., membership in the Association of Information Technology Professionals—AITP), corporate formation documents, military discharge certificate, community group information, church affiliation, and references, into the Verification module. The candidate has also uploaded a photo and video into the Photo/Video Module, enabled a temporal link for Facebook, and uploaded a credit report and criminal background check into the Pre-Employment Screening Module. Because the job seeker may wish to upload all of his/her information, but may not necessarily wish to send all of that information to each and every prospective employer/recipient, there are several information filters available within the software of the present invention.

For the Verification Module, one filter is shown by the “All/Selective” switch, which may similarly appear in a web page hosted by the program administrator, which is denoted as the Résumé ID Corp within FIG. 8A. By toggling the “All” side of the switch, every item that has been uploaded into the Verification Module would be available for viewing by that Prospective Employer. The graphical user interface of the software may alert the user as to selections made and corresponding information availability, by using bold borders, lines, and text. In FIG. 8A, the “All” side of the switch has been made bold and larger than the reciprocal option of “selective.” In addition, each block of the Verification Module to which information has been uploaded has a bold border, and a bold connector line, connecting it to the Verification Module Block.

With respect to the selecting of which modules are to be sent to the prospective employer/recipient, the graphical user interface may permit the user of the software to toggle the desired modules, after which it may assign a symbol or character to more positively identify its selection, in addition to, or in place of using the bold blocks. In FIG. 8A, the Greek letter Ψ was utilized by the system to identify all of the modules that the candidate intends to make available to a Prospective Employer “A,” which is evidenced by the use of the Ψ symbol next to the block for that employer. The candidate selected for viewing by Employer A, the Résumé Module, the Verification Module, the Photo/Video Module, the Facebook Module, and the Pre-Employment Screening Module, but only the Credit Report therein, and not the criminal history report. Note that the Pre-Employment Screening Module may have an “All/Selective” switch that operates the same as the switch for the Verification Module.

Once the candidate has uploaded all of the desired information, identified a prospective employer within an information box in the graphical user interface, and selected the information to be sent thereto, the Résumé ID system may assign a Globally Unique Identifier (GUID) for the transaction, and delivers it to the candidate. This delivery may be electronic, being within the system software that requires password access, or it may be e-mailed to the user, or it may be sent on paper using regular mail through the post office.

With regard to the GUID, it may comprise a visual image. The GUID may be a randomly generated image that serves to identify the associated data that is stored within the database, or it may be a programmatically encoded ID. The coded ID may be in the form of a bar code, such as the Universal Product Code (UPC) having 12 numerical digits represented by a scannable strip of black bars and white spaces, or the European Article Number (EAN), being a 13 digit (12 data and 1 check) bar coding standard, or it may be a two-dimensional barcode. In general, a barcode is an optical machine-readable representation of data, being represented by varying the width and spacing of a series of parallel lines. The traditional linear or uni-dimensional barcode stores information horizontally and thereby records and permits retrieval of data about the object to which it is associated. Ordinarily, the data may be retrieved through the use of a special optical scanner known as a barcode reader. A two-dimensional (2D) barcode is a similar type of graphical image, however, it stores information both horizontally and vertically, with this construction permitting the storage of thousands of characters, which is significantly greater than the 20-character capacity of standard unidimensional barcodes. A two-dimensional matrix barcode consists of black and white cells that are arranged in square or rectangular patterns. The information encoded within such a matrix barcode can be either text or raw data. A Data Matrix symbol can store thousands of alphanumeric characters.

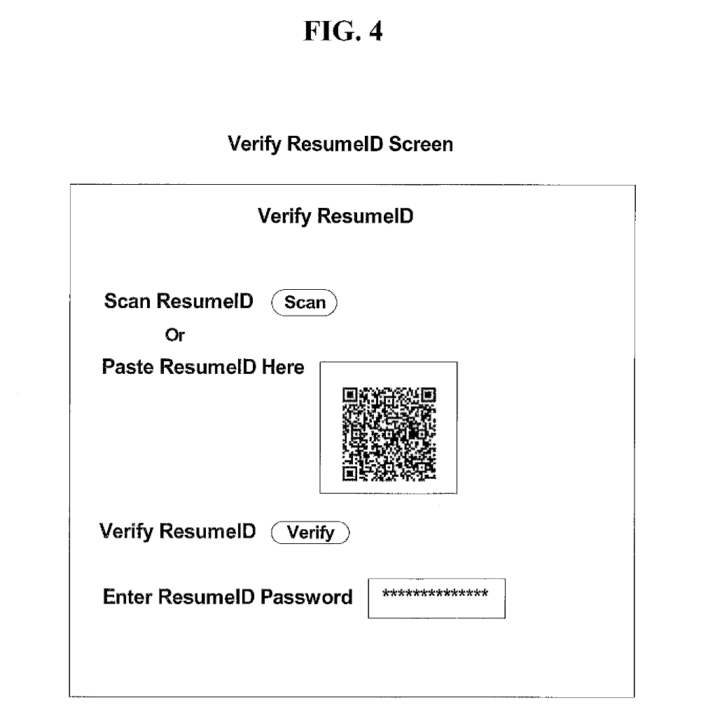

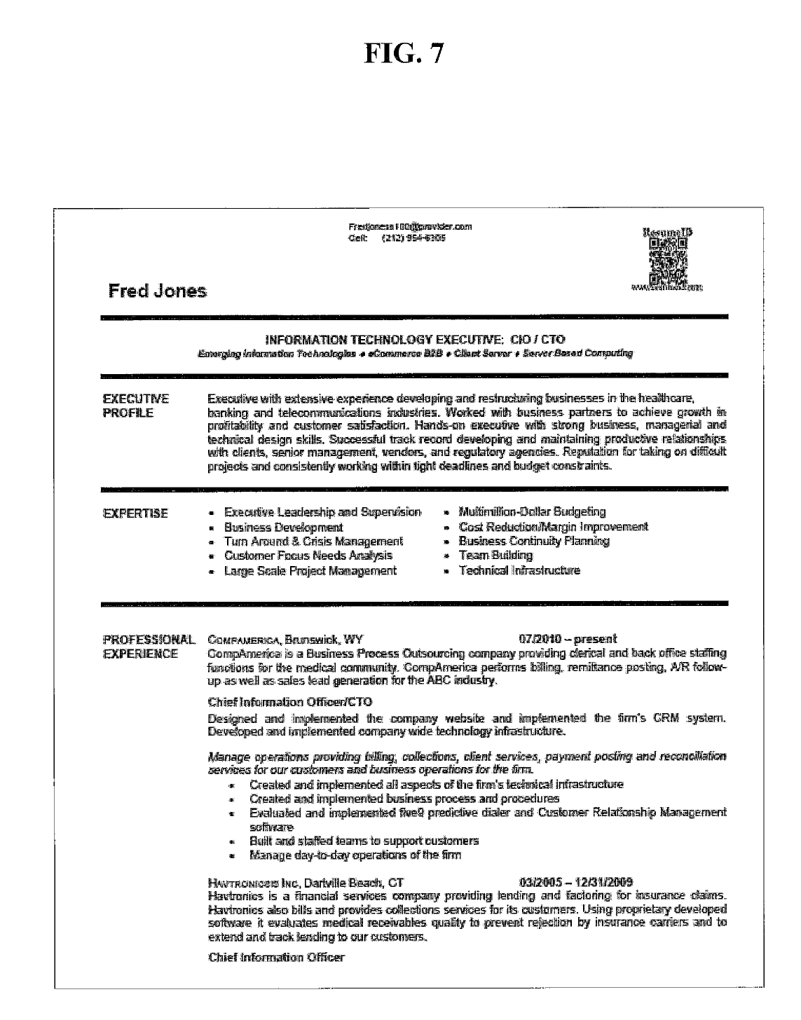

The coded ID may also be in the form of a Quick Response (QR) bar code, which is a matrix bar code that was designed to allow its contents to be decoded at high speed, and may thus be quickly read by a cell phone. The QR code is readily identifiable by its three distinctive squares at the corners of the image (see FIGS. 4 and 7). More detailed information regarding the specifications for, and use of, barcodes may be found in the book titled, “The Bar Code Book: Fifth Edition—A Comprehensive Guide To Reading, Printing, Specifying, Evaluating, And Using Bar Code and Other Machine-Readable Symbols,” by Roger C. Palmer, and in the website at www.adams1.com/stack.html, the disclosures of each being incorporated herein by reference. A three-dimensional barcode may also be used for the GUID of the present invention.

In the Resume ID System of the present invention, the candidate may also enter the text for a cover letter into a Cover Letter Module, in which case the system may automatically load the company name and address and name of the recipient into the cover letter. Once the candidate is satisfied with the information package to be sent to the prospective company, a “send” button may be toggled that causes the system software to e-mail the cover letter and résumé to the company, along with a description about how the system operates. The résumé may contain a company-specific GUID on it, as seen in FIG. 7. If the user decides not to enter cover letter information, as seen in FIG. 8A for candidate Fred Jones, then the system would e-mail the QUID directly to the candidate, who may forward it to the employer with a cover letter, using any means desired by the candidate—emailing it to the company with an electronic cover letter, or sending via regular mail with a printed cover letter (and résumé). Contact via e-mail may be a preferred approach for most users of the system, and is thus illustrated within FIG. 8A.

Once the company receives the cover letter and GUID, the recipient—a personnel representative therein—may then access the website of the Résumé ID Company, and submit the GUID to be able to view the full extent of information the candidate intended to disclose as part of the job application. Once the Prospective Employer A accesses the candidate's information, a message may be sent to the candidate acknowledging that the information has been viewed. In the graphical user interface available to the candidate, a date of access by Employer A may be displayed on the data structure (see FIG. 8A—“Jul. 4, 2012”).

The GUID in the form of a bar code that is sent to the Prospective Company may contain all of the candidate's information thereon, but in an encoded format, so that when it is submitted to the Résumé ID Company, the Résumé ID Company website merely decodes and visually displays the information to the personnel staff member at the Company. The viewing may be set to be temporary, having a time limit, or it may allow unlimited viewing. The candidate may also be provided an option in the graphical user interface to disable the barcode at any time after it is sent, to prevent future viewing of the data, such as when the candidate receives an offer and no longer wishes to have the information available for viewing, or if the candidate discovers a mistake in the information that was sent. Alternatively, the bar code may merely serve as a key to unlock the data that is stored within the Résumé ID Company website. A password may additionally be required for access.

The GUM submitted to the Prospective Company A may thus constitute a paired security arrangement, where only that particular company may gain access to the designated information using that identifier. Another security option may simply be to make the information openly available to the public.

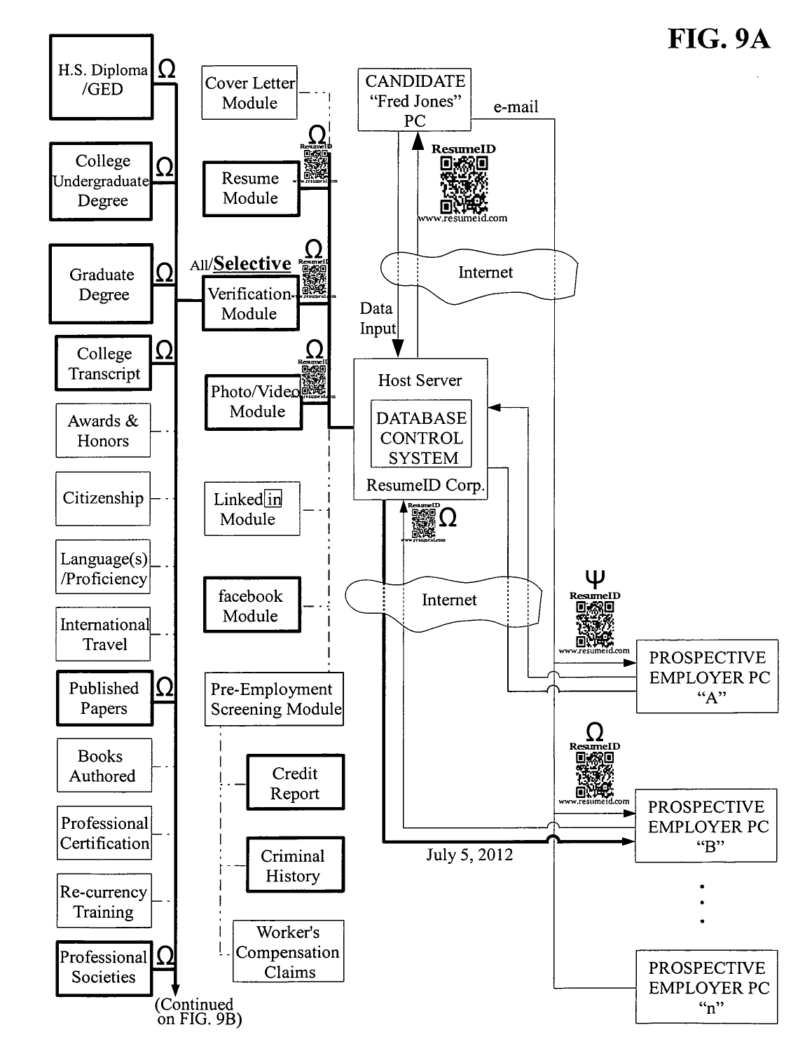

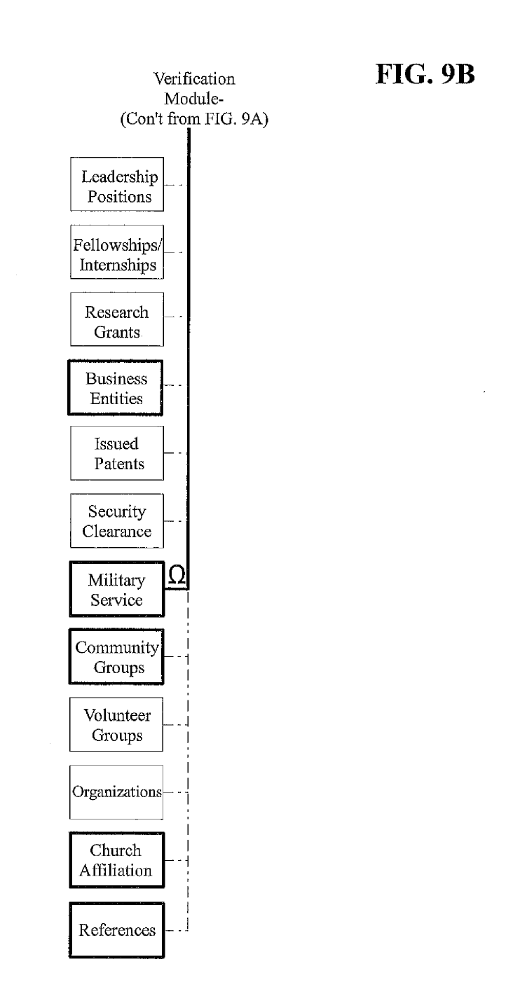

FIGS. 9A and 9B illustrate the situation where a candidate has customized the distribution of his personal information differently for a second possible job opportunity. For a Prospective Employer B, candidate Fred Jones has switched the Verification Module to “Selective” and decided not to make available the documentation relating to the company he had formed in the past, as well as the documentation for the community groups, church affiliation, and references that he made available to Prospective Company A, nor is the Facebook link, the credit report, or the criminal history report going to be available to Company B. The presence of the data is nonetheless indicated to the candidate by the bold box around “Business Entities,” etc., but the connector line is not bold and may furthermore be dashed to indicate it will not be available to that recipient. The Verification Module data and other module data that will be available for viewing by Prospective Company B is signified in FIGS. 9A and 9B by the Greek Letter Ω. The date that such information may have been viewed may also be indicated in graphic relation to that company. Since a Customer may have sent more than one Résumé ID to various different companies, the system may have a function to display all the Resume IDs that have been sent, along with the issue/sending date, type of security, and the status of the Résumé ID-viewed or unviewed, active or disabled, etc.

Viewing of the data after submitting of the GUID by the Prospective Company A may be as seen in FIG. 5A, while the viewing of the information intended for Prospective Company B may be as seen in FIG. 5B. Alternatively, rather than viewing of each document individually by selecting a button, all of the documents permitted to be viewed by the Prospective Company may instead be displayed in successive pages of a PFD document, so that the personnel staff member may simply page through all of the data that was made available.

Software of the present invention may run on a computer and/or server, so a description of such an accessorized exemplary computer system is hereinafter disclosed, even though a particular embodiment may not require all of the described components. Exemplary computer system 200 is shown schematically in FIG. 9, and which may comprise computing unit 201 interacting with external peripherals 202, such as a separate touch screen display 244, and interacting with network resources 203, including use of the internet 261, and other computers, which may be first and second laptop computers 262/263, and/or a tablet, a smart phone etc.

The computing unit 201 may include a data bus 224 for communicating information across and among various parts of computing unit 201, and a central processing unit, which may be a microprocessor (hereinafter “processor” or “CPU”) 222 coupled with a bus 224 for processing information and performing other computational and control tasks. Computing unit 201 may also include a volatile storage 225, such as a random access memory (RAM) or other dynamic storage device, coupled to bus 224 for storing various information as well as instructions to be executed by processor 222. The RAM may be Dynamic Random Access Memory (DRAM), or Static RAM (SRAM), or any other similar type of RAM known in the art. The volatile storage 225 may also be used for storing temporary variables or other intermediate information during execution of instructions by processor 222. Computing unit 201 may further include a read only memory (ROM) or an erasable programmable memory (EPROM) 227 or other static storage device coupled to bus 224 for storing static information and instructions for processor 222, such as basic input-output system (BIOS), as well as various system configuration parameters. A persistent storage device or non-volatile memory 226, such as a magnetic disk, optical disk, or solid-state flash memory device may be provided and may be coupled to bus 224 for storing information and instructions.

Computing unit 201 may be coupled via bus 224 to an integral display 221, possibly a touch-screen display, for use in displaying information to a user. If desired, computing unit 201 may be coupled via bus 224 to an external display screen 244. An external input device 243 (e.g., a standard keyboard) may be coupled to bus 224 for communicating information and command selections to processor 222. A cursor control device 242, such as a mouse, a trackball, or cursor direction keys, may be used for communicating direction information and command selections to processor 222 and for controlling cursor movement on display 244. An external storage device 241 may be connected to the computing unit 201 via bus 224 to provide an extra or removable storage capacity for the computing unit 201, which may be used to facilitate exchange of data with other computer systems.

Some of the techniques herein may be performed by computing unit 201 in response to processor 222 executing one or more sequences of one or more instructions contained in the volatile memory 225. Execution of the sequences of instructions contained in a memory may cause processor 222 to perform the process steps described herein. In alternative embodiments, specific hard-wired digital circuitry may be used in place of, or in combination with, software instructions to implement the invention.

The term “computer-readable medium” as used herein refers to any medium that participates in providing instructions to processor 222 for execution. The computer-readable medium is just one example of a machine-readable medium, which may carry instructions for implementing any of the methods and/or techniques described herein. Various forms of computer readable media may be involved in carrying one or more sequences of one or more instructions to processor 222 for execution, including non-volatile media (storage device 226), and volatile media (storage device 225). Common forms of computer-readable media include, for example, a floppy disk, a hard disk, magnetic tape, or any other magnetic medium, a CD-ROM, any other optical medium, a RAM, a PROM, an EPROM, a flash drive, and a memory card.

The computing unit 201 may thus also include a communication interface, such as network interface card 223 coupled to the data bus 222. Communication interface 223 may provide a two-way data communication coupling to a network link that may be connected to a local network. For example, communication interface 223 may be an integrated services digital network (ISDN) card or a modem to provide a data communication connection to a corresponding type of telephone line, or it may be a local area network interface card (LAN NIC) to provide a data communication connection to a compatible LAN.

Network link 223 also typically provides data communication to other network resources. For example, the network link may provide a connection over the internet 261 to the world-wide-web. Thus, the computing unit 201 can access resources located anywhere using the Internet 261. Also, the computing unit 201 may also be accessed by other computers (e.g. 262-263), generally with permission, and which may be located anywhere with access to the internet 261.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

We claim:

1. A computer readable medium having stored thereon instructions that, when executed, direct a computer system to display one or more screens to accommodate a process of distributing qualifications of a job seeker to one or more hiring entities or one or more agents of a hiring entity, said process comprising the following steps:
registering, by a customer, using a customer login web page hosted by a server computer;
storing personal data of the customer in a memory in said computer system by populating said data respectively into one or more of a résumé module, a photo/video module, a verification module, a pre-employment screening module, and a facebook module;
choosing a distribution security scheme for at least one of the one or more hiring entities or of the one or more agents;
assigning of a GUID by the server computer corresponding to the selective data and the chosen security scheme, thereby permitting secure access according to the selected distribution security scheme for the at least one hiring entity or agent;
sending, by the customer, of said bar code, to said at least one hiring entity or agent;
accessing, by said at least one hiring entity or agent, of the personal data of the customer by submitting said bar code to the server computer; and
displaying of a customer information screen and viewing, by said at least one hiring entity or agent, of one or more pieces of said stored personal data of the customer in said résumé module, said photo/video module, said verification module, said pre-employment screening module, and/or said facebook module.

2. A computer operated method for distributing qualifications of a job seeker to one or more hiring entities or one or more agents of a hiring entity, the method comprising the steps of:
registering, by a customer, using a customer login web page hosted by a server computer;
uploading personal data securely, by the customer, into the server computer to populate one or more data fields;
selecting of a filter and a distribution security scheme for said uploaded personal data;
sending, by said server computer, of a bar code to the customer;
sending, by the customer, of said bar code, to one or more hiring entities or an agent thereof;
receiving, by the one or more hiring entities or an agent thereof, of said bar code;
accessing of the personal data of the customer, by the one or more hiring entities or the agent thereof, by submitting said bar code to the server computer;
displaying of a customer information screen being selectively coupled to one or more pieces of said uploaded personal data of the customer; and
viewing of the personal data of the customer, by the one or more hiring entities or the agent thereof, according to said filter.

3. The computer operated method for distributing qualifications of a job seeker according to claim 2 further comprising tracking, by the customer, of a time and date of said viewing, by the one or more hiring entities or the agent thereof, of the selectively coupled one or more pieces of personal data.

4. The computer operated method for distributing qualifications of a job seeker according to claim 3 wherein said uploading of said personal data comprises uploading of one or more of the following:
a cover letter;
a résumé;
a photograph;
a video;
a temporary portal permitting facebook access;
pre-employment screening data; and
qualification data.

5. The computer operated method for distributing qualifications of a job seeker according to claim 4 wherein said uploading of said pre-employment screening data comprises uploading of one or more of the following:
a credit report;
a criminal background report; and
a worker's compensation claim search report.

6. The computer operated method for distributing qualifications of a job seeker according to claim 5 wherein said uploading of said qualification data comprises uploading of one or more of the following:
a high school diploma;
a trade school diploma;
an undergraduate degree diploma;
a graduate degree diploma;
a school or college transcript;
an award or honors certificate;
a proof of citizenship document;
a language proficiency test result;
a passport information page;
a stamped passport travel page;
a published paper;
a published book;
a professional certification document;
an issued patent;
a recurrency training certificate;
a professional society membership certificate;
a leadership certificate;
a certificate evidencing a fellowship or internship;
a research grant document;
a business formation document;
a security clearance;
a military service certificate of discharge;
a community group certificate of participation;
a volunteer group certificate of participation;
an organizational certificate of participation;
a certificate of church membership;
a professional reference.

7. The computer operated method for distributing qualifications of a job seeker according to claim 6 wherein said uploading of a proof of citizenship document comprises uploading of one or more of the following:
an issued and undamaged passport;
a certified birth certificate;
a consular report of birth of a U.S. citizen or a certification of birth;
a naturalization certificate; and
a certificate of citizenship.

8. The computer operated method for distributing qualifications of a job seeker according to claim 7 wherein said accessing of said personal data of the customer by said one or more hiring entities or the agent thereof further comprises submitting of a password.

9. The computer operated method for distributing qualifications of a job seeker according to claim 8 wherein said bar code is sent to the customer via e-mail or via regular mail or in person.

10. The computer operated method for distributing qualifications of a job seeker according to claim 9 wherein said registering comprises entering a user ID and password.

11. The computer operated method for distributing qualifications of a job seeker according to claim 10 wherein said selecting of a distribution security scheme comprises selecting of: a public security arrangement, a private security arrangement, or a paired security arrangement.

12. The computer operated method for distributing qualifications of a job seeker according to claim 11 wherein said selecting of a distribution security scheme comprises inputting a required password for said accessing.

13. The computer operated method for distributing qualifications of a job seeker according to claim 12 wherein said accessing of the personal data by the one or more hiring entities or the agent thereof, further comprises registering by one or more hiring entities or the agent thereof.

14. A process of distributing qualifications of a job seeker to one or more hiring entities or one or more agents of a hiring entity, using a computer system, said process comprising the following steps:
using one or more processors to execute instructions retained in a machine-readable storage media to cause said computer system to cause the display of one or more screens for use in executing said process;
registering for said process, by a customer using a customer computer, by accessing of a customer login web page hosted by a program administrator computer, said customer computer being coupled to communicate with said program administrator computer;
storing, by the customer, of personal data of the customer in a memory in said program administrator computer system by populating said data respectively into a résumé module, a photo/video module, a verification module, and a pre-employment screening module;
choosing, by the customer, of a distribution security scheme for at least one of the one or more hiring entities or one of the one or more agents;
assigning of a bar code ID, by the program administrator computer, corresponding to the data and to the chosen security scheme, thereby permitting secure access according to the selected distribution security scheme for said at least one hiring entity or agent;
sending, by the customer, of said bar code, to said at least one hiring entity or agent;
receiving, by said at least one hiring entity or agent, of said bar code using a hiring entity or agent computer, said hiring entity or agent computer being coupled to communicate with said customer computer and with said program administrator computer;
accessing, by said at least one hiring entity or agent, of the personal data of the customer by submitting said bar code from said hiring entity or agent computer to said program administrator computer; and
displaying of a customer information screen and viewing, on said at least one hiring entity or agent computer, of one or more pieces of said stored personal data of the customer in said résumé module, said photo/video module, said verification module, said pre-employment screening module, and/or said facebook module.
